(19) United States
(12) Patent Application Publication
(10) Pub. No.: US 2026/0145881 A1
(43) Pub. Date: May 28, 2026

(54) LAB MATERIAL CONVEYING DEVICE, CONVEYING BELT DEVICE AND EQUIPMENT

(71) Applicant: CHEMLEX PTE. LTD., SINGAPORE (SG)

(72) Inventors: Haibin XU, SINGAPORE (SG); Chao LU, SINGAPORE (SG)

(73) Assignee: CHEMLEX PTE. LTD., SINGAPORE (SG)

(21) Appl. No.: 18/957,886

(22) Filed: Nov. 25, 2024

(51) Int. Cl. B65G 37/02; B65G 1/06; B65G 1/12; B65G 17/34

(52) U.S. Cl. CPC B65G 37/02; B65G 1/06; B65G 1/12; B65G 17/345; B65G 2812/02227

(57) ABSTRACT

The present disclosure proposes a laboratory material conveying device, a conveying belt device and an equipment, the laboratory material conveying device comprising a vertical lifting mechanism, a first rotating mechanism and a first horizontal conveying mechanism, the first horizontal conveying mechanism being provided on the first rotating mechanism, the first rotating mechanism being mounted on the vertical lifting mechanism, the first horizontal conveying mechanism being placed on the carrier, and the carrier is provided with a holding space for holding the material to be conveyed.

### FIELD

The present disclosure belongs to the field of material transportation, and specifically relates to a laboratory material conveying device, a conveying belt device and equipment.

### BACKGROUND OF THE DISCLOSURE

Automation lab is a set of automatic testing, automatic control and other means and technology as a whole for experiments related to the operation of the equipment, the use of automation lab for experiments, can effectively improve production efficiency and operational accuracy.

In the process of material transportation, the conveying angle and conveying distance of the automated lab conveying mechanism are limited, and it is not possible to realize multi-angle and long-distance conveying on the same equipment and different equipment, in order to enrich the conveying angle and conveying distance of the automated lab conveying mechanism, it is often necessary to use additional mechanisms, such as robotic arms, AGV, etc., which, due to the increase in the number of additional mechanisms, improves the complexity of the equipment, and in turn, raises the production, assembly and maintenance costs. In addition, the movement accuracy of the chain action between each mechanism is required to be higher, and due to more mechanisms, the conveying process is prolonged, the working efficiency is low, and the adaptability to high-speed work scenes is poor. Due to more structural actions increase the risk of material leakage and spillage in the transportation process, in order to avoid leakage and spillage, the horizontal conveying path is often used, resulting in a complex conveying path, which is prone to mechanical injury accidents.

Therefore, there is an urgent need for a material transportation device that is capable of multi-angle conveying and has a relatively simple structural action.

### BRIEF SUMMARY OF THE DISCLOSURE

In order to be able to solve at least one of the technical problems raised above, the present disclosure proposes a lab material conveying device, a conveying belt device and an equipment, while the present disclosure can realize a multi-angle conveying purpose without the help of an additional mechanism, which makes the structure simple and greatly improves the working efficiency.

According to an aspect of the present disclosure, a laboratory material conveying device, the laboratory material conveying device comprises a vertical lifting mechanism, a first rotating mechanism and a first horizontal conveying mechanism, the first horizontal conveying mechanism being provided on the first rotating mechanism, the first rotating mechanism being mounted on the vertical lifting mechanism, the first horizontal conveying mechanism on which a carrier is placed, the carrier being provided with a holding space for accommodating the material to be conveyed.

In some possible embodiments, the laboratory material conveying device further comprises a drive motor, the drive motor being provided in a lower part of the first rotating mechanism, the drive motor being electrically connected to the first rotating mechanism.

In some possible embodiments, the laboratory material conveying device further comprises a mounting bracket, the first rotating mechanism and the drive motor being mounted on the vertical lifting mechanism via the mounting bracket.

In some possible embodiments, the first horizontal conveying mechanism is a belt conveying mechanism, the belt conveying mechanism comprising a transmission mechanism, which is provided with a winding belt, the transmission mechanism having a rotating direction in a counterclockwise direction or a clockwise direction.

In some possible embodiments, the first horizontal conveying mechanism is provided with a barrier structure, the barrier structure being located at a first predetermined location of the first horizontal conveying mechanism; the first predetermined location being, in the direction of the plumb line of the working surface of the first horizontal conveying mechanism, at a first predetermined distance from the working surface of the first horizontal conveying mechanism, the first predetermined distance being less than the height of the carrier;

the working surface of the first horizontal conveying mechanism is the surface of the first horizontal conveying mechanism in contact with the carrier.

In some possible embodiments, the laboratory material conveying device further comprises a sensor, the sensor being mounted on the side of the first horizontal conveying mechanism.

According to another aspect of the present disclosure, there is also disclosed a conveying belt device, the conveying belt device comprises a conveying belt, at least one slide structure, at least one laboratory material conveying device, a second horizontal conveying mechanism and a second rotating mechanism, the second horizontal conveying mechanism being slidably arranged on the slide structure via the second rotating mechanism, and the slide structure and the laboratory material conveying device being provided in the surrounding area of the conveying belt respectively.

In some possible embodiments, the conveying belt comprises a first predetermined number of first conveying belts transforming the track, and the angle between the first conveying belt with the first predetermined number and the slide structure ranges from 0-180°.

In some possible embodiments, the conveying belt comprises a second predetermined number of second conveying belts changing the conveying direction, the angle between two adjacent the second conveying belts ranging from 0-180°.

In some possible embodiments, the conveying belt device further comprises a third rotating mechanism and a third horizontal conveying mechanism provided on the third rotating mechanism, the third horizontal conveying mechanism and the third rotating mechanism being provided between adjacent the second conveying belts; the third horizontal conveying mechanism has a working surface in the same plane as the working surface of the adjacent the second conveying belt.

In some possible embodiments, the conveying belt further comprises a third conveying belt docked with the vertical lifting mechanism, the third conveying belt is arranged in a direction perpendicular to the vertical lifting mechanism; the end of the third conveying belt being close to the vertical lifting mechanism is a second predetermined distance away from the vertical lifting mechanism, the second predetermined distance being greater than or equal to the overall length of the first horizontal conveying mechanism and less than a predetermined distance threshold.

In some possible embodiments, the working surface of the first horizontal conveying mechanism and the working surface of the target conveying belt are in the same horizontal plane when the distance of the plumb line segment between the working surface of the first horizontal conveying mechanism and the bottom plane of the vertical lifting mechanism is a third predetermined distance;

the working surface of the first horizontal conveying mechanism is the surface on the first horizontal conveying mechanism in contact with the carrier, and the target conveying belt is a third conveying belt to be reached by the carrier, and the working surface of the target conveying belt is the surface on the target conveying belt in contact with the carrier.

In some possible embodiments, the conveying belt comprises a conveying belt shell and a conveying belt body, the conveying belt shell being fixedly arranged on a working surface of the conveying belt body.

According to another aspect of the present disclosure, an equipment is also disclosed, the equipment comprising the conveying belt device.

The technical solution provided by embodiments of the present disclosure has the following technical effects:

(1) The present disclosure makes the first horizontal conveying mechanism free to rotate to various angles on the same horizontal plane by setting the first rotating mechanism below the first horizontal conveying mechanism, enables vertical lifting and horizontal moving at the same time by mounting the first horizontal conveying mechanism on a vertical lifting mechanism, simplifies the structure of the equipment, can reduce the cost of the equipment's manufacturing, assembling, and maintenance, simplifies the process of transporting the material, saves the material transportation time, improve the efficiency of material transportation, reduce the possibility of material loss during transportation, realize the multi-angle transportation of the laboratory material conveying device, improve the work efficiency, by setting the first horizontal conveying mechanism on the first rotating mechanism, adjust the angle of the first rotating mechanism, so that the location of the first horizontal conveying mechanism can correspond to the entrance of the conveying belt, overcoming the problem of a single direction of conveying. It can reduce the probability of dumping of materials and improve the stability and safety of the material transportation process.

(2) The embodiment of present disclosure, by setting up a variety of conveying belts, slide structures, laboratory material conveying devices and other mechanisms in the conveying belt device, enables the material transportation to reach any horizontal plane in the vertical direction, and then converts it to the horizontal direction, and changes the angle of the transportation direction and the track in the same horizontal plane, and is able to flexibly set up the transportation path according to the specified location, and transport the material to the specified location, and improves the flexibility of the material transportation. Due to the combination of a variety of transport belts and laboratory material conveying devices with vertical lifting function, compared with linear transportation, it can improve the integration of equipment in the space, increase the utilization of space, shorten the material conveying path, reduce the possibility of material dumping, and further ensure the safety of experiments and environmental cleanliness.

(3) In this embodiment of the disclosure, a material conveying device is arranged in the device so that the material can be transported to horizontal planes at different heights. The same horizontal plane can also achieve a variety of angles of transformation, improving the flexibility of material transportation. By arranging the first conveying belt, the second conveying belt, and the third conveying belt among the equipments, and by adjusting the arrangement of the starting points of the conveying belts, and arranging the first horizontal conveying mechanism, the second horizontal conveying mechanism, and the third horizontal conveying mechanism between the conveying belts, which cooperate with the first rotary mechanism, the second rotary mechanism, and the third rotary mechanism, respectively, a variety of material transportation routes can be freely set between different devices as needed, improving the efficiency and flexibility of transporting materials in the laboratory. Compared to the pure linear transport of materials, it saves space for the layout of the transport device, improves the effective use of space, and avoids long-distance transport, thereby reducing the risk of materials spilling. It does not need to rely on the assistance of other external equipment, reduces the structural complexity of the material conveying device, and thereby saves the device costs.

### BRIEF DESCRIPTION OF THE DRAWINGS

In order to more clearly illustrate the technical solutions and advantages in the embodiments or prior art of the present disclosure, the accompanying drawings to be used in the description of the embodiments or prior art will be briefly introduced below, and it will be obvious that the accompanying drawings in the following description are only some of the embodiments of the present disclosure, and that for those skilled in the art, other drawings can be obtained based on these drawings without putting forth any creative labor.

FIG. 1 is a schematic diagram I of the structure of a laboratory material conveying device provided by an embodiment of the present disclosure;

FIG. 2 is a schematic diagram II of the structure of a laboratory material conveying device provided by an embodiment of the present disclosure;

FIG. 3 is a schematic diagram of the structure of a conveying belt device provided by an embodiment of the present disclosure;

FIG. 4 is a schematic diagram I of a structure of a first conveying belt provided by an embodiment of the present disclosure;

FIG. 5 is a schematic diagram II of the structure of a first conveying belt provided by an embodiment of the present disclosure;

FIG. 6 is a schematic diagram of the structure of a second conveying belt provided by an embodiment of the present disclosure;

FIG. 7 is a schematic diagram of the structure of a third conveying belt provided by an embodiment of the present disclosure;

FIG. 8 is a working schematic diagram I of an equipment provided by an embodiment of the present disclosure;

FIG. 9 is a working schematic diagram II of an equipment provided by an embodiment of the present disclosure.

### DETAILED DESCRIPTION OF THE DISCLOSURE

The technical solutions in the embodiments of the present disclosure will be clearly and completely described below in conjunction with the drawings in the embodiments of the present disclosure, and it is clear that the described embodiments are only a part of the embodiments of the present disclosure and not all of the embodiments. All other embodiments obtained by those skilled in the art without creative effort based on the embodiments in the present disclosure fall within the scope of protection of the present disclosure.

It should be noted that the term “embodiment” or “embodiments” in the specification of the present disclosure example refers to specific features, structures or characteristics that may be included in at least one embodiment of the present disclosure. It should be understood that in the specification and the Claims of the embodiments of the present disclosure and the aforementioned drawings, the terms “upper”, “lower”, “top”, “bottom”, etc., that indicate a direction or location relationship, are based on the direction or location relationship shown in the drawings, and are provided for the purpose of facilitating the description of the present disclosure and simplifying the description. They are not intended to indicate or imply that the referred device or element must be constructed and operated in a particular direction or location, and thus should not be understood as limitations to the present disclosure. The terms “first” and “second” are used for descriptive purposes only and are not to be understood as indicating or implying a relative importance or as implying that the number of technical features indicated is limited to that number. Accordingly, features that are qualified with “first” or “second” can expressly or implicitly include one or more of such features. Furthermore, the terms “first” “second” etc. are used to distinguish similar objects and do not necessarily indicate a specific order or sequence. It should be understood that the data so used may be interchangeable where appropriate, so that the embodiments of the present disclosure described herein can be implemented in a sequence other than those illustrated or described herein. In addition, in the description of the embodiments of the present disclosure, unless otherwise specified, “multiple” means two or more. In addition, the terms “comprising” and “having” and any variations thereof are intended to cover non-exclusive inclusion. In order to make the purpose, technical solution and advantages of the embodiments of the present disclosure clearer, the embodiments of the present disclosure are further described in detail below in conjunction with the drawings and examples. It should be understood that the specific embodiments described herein are provided for the sole purpose of explaining the embodiments of the present disclosure and are not intended to limit the embodiments of the present disclosure.

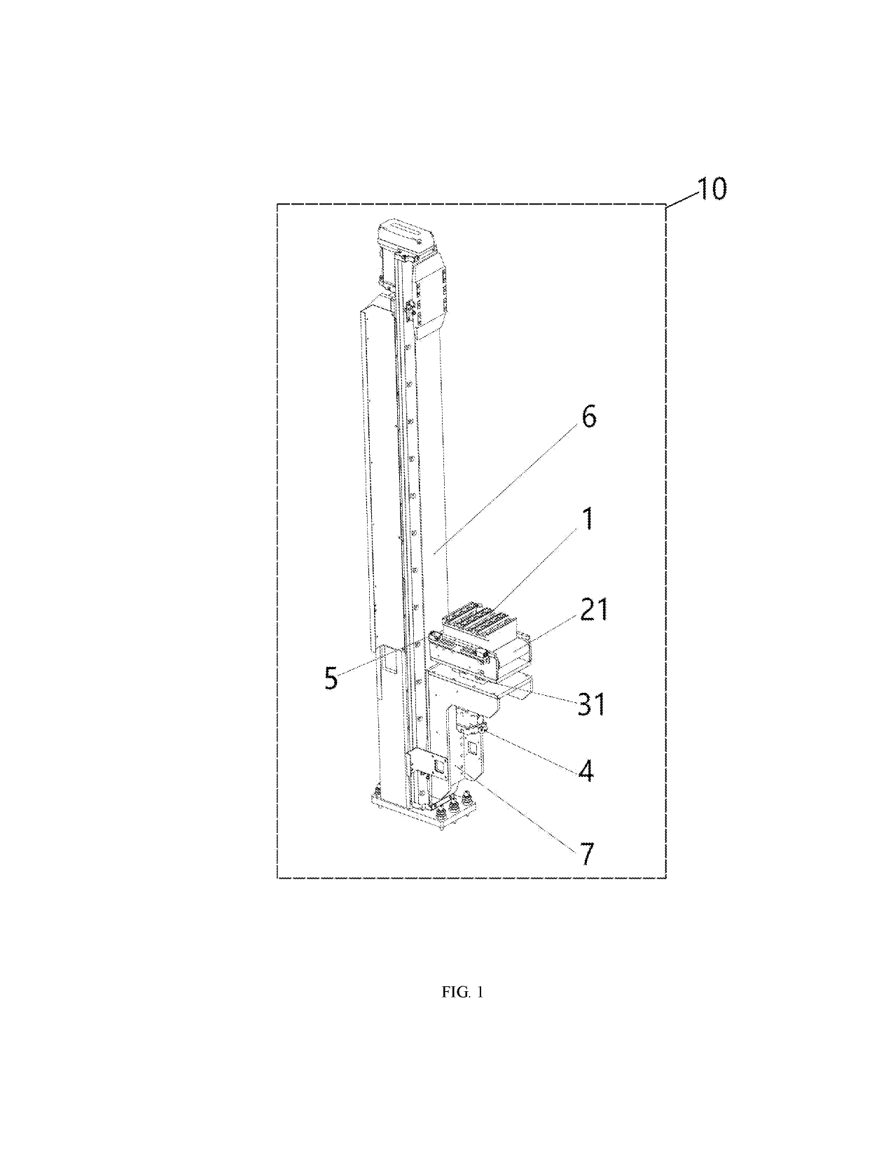

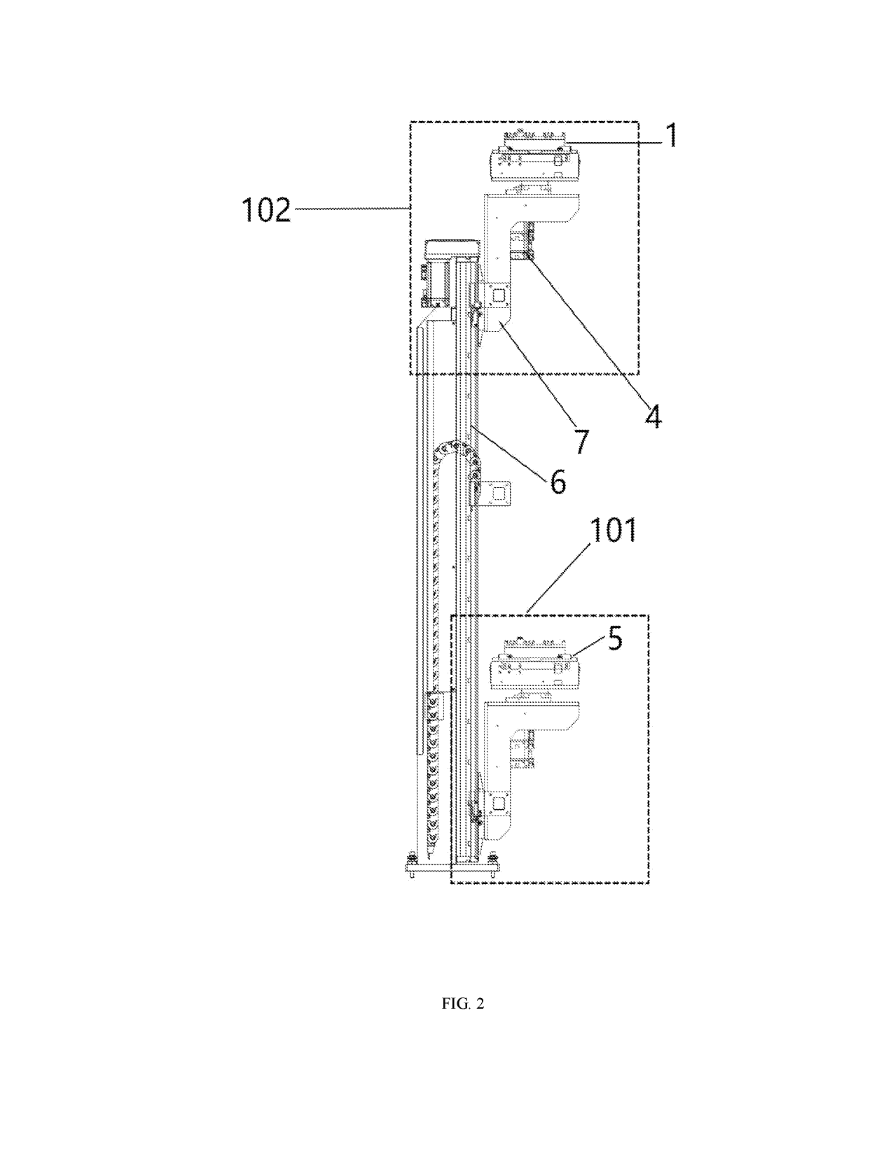

Please refer to FIGS. 1 and 2, FIG. 1 is a schematic diagram I of the structure of a laboratory material conveying device provided by an embodiment of the present disclosure, and FIG. 2 is a schematic diagram II of the structure of a laboratory material conveying device provided by an embodiment of the present disclosure, as shown by the dotted box in FIG. 1, the present disclosure proposes a laboratory material conveying device 10, the dotted box specifically comprising a plurality of component structures, the laboratory material conveying device comprising a vertical lifting mechanism 6, a first rotating mechanism 31 and a first horizontal conveying mechanism 21, the first horizontal conveying mechanism 21 being provided on the first rotating mechanism 31, the first rotating mechanism 31 being mounted on the vertical lifting mechanism 6, the first horizontal conveying mechanism 21 on which a carrier 1 is placed, the carrier 1 being provided with a holding space for accommodating the material to be conveyed.

In the practical application of automated labs, the material transportation device needs to transport the material to different equipment or different experimental modules in the same equipment, accordingly, the material transportation device needs to transport the material to different conveying belts, and then through the conveying belts the material will be transported to other equipment or different experimental modules in the same equipment. It can be seen that the target location of each material transportation may be different. In order to smoothly transport the materials to different conveying belts, the first horizontal conveying mechanism 21 can be driven by the first rotating mechanism 31 to rotate the first horizontal conveying mechanism 21 by a suitable angle, so that the horizontal conveying direction of the first horizontal conveying mechanism 21 can coincide with the conveying direction of the different conveying belts, which in turn drives the first horizontal conveying mechanism 21 to smoothly deliver the carrier 1 to the different conveying belts along the horizontal conveying direction.

It is noted that the first horizontal conveying mechanism 21 is used to convey the carrier 1 to the target location along the conveying direction of the first horizontal conveying mechanism 21, the vertical lifting mechanism 6 is used to transport the carrier 1, the first horizontal conveying mechanism 21, and the first rotating mechanism 31 together from the initial working position 101 to the final working position 102, and the first rotating mechanism 31 is used to adjust the angle between the first horizontal conveying mechanism 21 direction and the angle between the target conveying belt.

Specifically, the following example illustrates the principle of operation of the laboratory material conveying device 10 of the present disclosure: a reagent bottle A is placed on a carrier 1, which needs to be transported from a first equipment 11 to a second equipment 12 via a conveying belt 8.

Please continue to refer to FIG. 2, when the first horizontal conveying mechanism 21 rises to the height of the final working position 102, if there exists a certain angle between the conveying direction of the first horizontal conveying mechanism 21 and the direction of the target conveying belt, for example, the angle is 90°, in order to ensure that the first horizontal conveying mechanism 21 is able to convey the carrier 1 to the target conveying belt in the appropriate state, the drive motor 4 is set in the first horizontal conveying mechanism 21 reaches the final working position 102, the angle between the conveying direction of the first horizontal conveying mechanism 21 and the direction of the conveying belt after the first rotating mechanism 31 is rotated by 90° is 0°, and rotation counterclockwise or clockwise is set according to the actual situation.

It is to be noted that the technical personnel in the field may understand that the embodiments described in this specification are used as aids to understanding the technical solution of the present application, and are not the only embodiments, and the order of implementation of the corresponding devices in the laboratory material conveying device 10 provided in the embodiments of the present application may be adjusted according to the needs, for example, the first horizontal conveying mechanism 21 can be raised to a certain position by controlling the vertical lifting mechanism 6 after rotating for a certain angle, or the first horizontal conveying mechanism 21 can be raised to a certain position by controlling the vertical lifting mechanism 6 before rotating counterclockwise or clockwise for a certain angle.

The present disclosure makes the first horizontal conveying mechanism free to rotate to various angles on the same horizontal plane by setting the first rotating mechanism below the first horizontal conveying mechanism, enables vertical lifting and horizontal moving at the same time by mounting the first horizontal conveying mechanism on a vertical lifting mechanism, simplifies the structure of the equipment, can reduce the cost of the equipment's manufacturing, assembling, and maintenance, simplifies the process of transporting the material, saves material transportation time, improves the efficiency of material transportation, reduces the possibility of material loss during transportation, realizes the multi-angle transportation of the laboratory material conveying device, and improves the work efficiency, and overcomes the problem of a single direction of conveying by installing the first horizontal conveying mechanism on the first rotating mechanism, and adjusting the angle of the first rotating mechanism, so that the location of the first horizontal conveying mechanism corresponds to the entrance of the conveying belt. It can reduce the probability of material dumping and spilling, and improve the stability and safety in the process of material transportation.

Please continue to refer to FIG. 2, wherein, as shown in FIG. 2, in some optional embodiments, the laboratory material conveying device further comprises a drive motor 4, the drive motor 4 being provided in a lower portion of the first rotating mechanism 31, the drive motor 4 being electrically connected to the first rotating mechanism 31.

Further, the drive motor 4 may be a servo motor. When the host computer issues an instruction, the drive motor 4 drives the first rotating mechanism 31 to rotate the first rotating mechanism 31 by a preset angle in a preset direction according to a preset setting, for example, driving the first rotating mechanism 31 to rotate 20° in the clockwise direction, or driving the first rotating mechanism 31 to rotate 40° in the counterclockwise direction.

By setting a drive motor in the lower part of the rotating mechanism, the embodiment of present disclosure makes the first horizontal conveying mechanism capable of flexibly adjusting the angle according to the need, improves the scene adaptability and flexibility of the material conveying device, and adopts a servo motor drive to improve the reaction speed and operation speed of the rotating mechanism, improves the working efficiency of the laboratory material conveying device, and saves the time of the material transportation.

Reference is further made to FIGS. 1 and 2, in some optional embodiments, the laboratory material conveying device further comprises a mounting bracket 7, the first rotating mechanism 31 and the drive motor 4 being mounted on the vertical lifting mechanism 6 via the mounting bracket 7.

The first horizontal conveying mechanism 21 is connected to the first rotating mechanism 31, the first rotating mechanism 31 is connected to the drive motor 4, thereby realizing the connection between the first horizontal conveying mechanism 21 and the drive motor 4, the drive motor 4 is connected to the mounting bracket 7, the first rotating mechanism 31 is mounted on the vertical lifting mechanism 6 through the mounting bracket 7, and by controlling the movement of the vertical lifting mechanism 6 the mounting bracket 7 is driven to move, thereby driving the first rotating mechanism 31, the first horizontal conveying mechanism 21 to perform vertical lifting movement. Therein, the mounting bracket 7 plays a good supporting role for the first rotating mechanism 31, the first horizontal conveying mechanism 21.

It is noted that the mounting bracket 7 comprises a first mounting plate for supporting the first horizontal conveying mechanism 21. Specifically, the mounting bracket 7 further includes a second mounting plate for supporting the first mounting plate, the second mounting plate comprising three mounting plates, the second mounting plate being provided at the bottom of the first mounting plate, and the second mounting plate being perpendicular to the first mounting plate, wherein the second mounting plate is connected to the track of the vertical lifting mechanism 6 and to the drive motor 4 via the sliding block structure. When the device switch is activated, the driving mechanism of the vertical lifting mechanism 6 drives the sliding block structure to slide along the track, and the sliding block structure drives the entire mounting bracket 7, as well as the first horizontal conveying mechanism 21, the first rotating mechanism 31, and the drive motor 4 that are connected to the mounting bracket 7, to make vertical lifting movements along the track.

The embodiment of present disclosure enhances the structural stability of the laboratory material conveying device by providing a mounting bracket to support the first horizontal conveying mechanism, the rotating mechanism, and the drive mechanism, thereby improving the stability of the material transportation, avoiding the loss caused by the material being spilled during the transportation process, providing support for the first horizontal conveying mechanism to be able to arrive at the target location, and improving the safety of the material transportation.

Please continue to refer to FIG. 1, as shown in FIG. 1, in some optional embodiments, the first horizontal conveying mechanism 21 is a belt conveying mechanism, the belt conveying mechanism comprises a transmission mechanism, the transmission mechanism is provided with a belt wrapped around it, and the transmission mechanism rotates in a counterclockwise direction or a clockwise direction.

The first horizontal conveying mechanism 21 is a belt conveying mechanism, the carrier 1 is placed on the surface of the belt conveying mechanism, and the carrier 1 is driven to move in a horizontal direction by belt rotation. It is to be noted that the first horizontal conveying mechanism 21 is used to realize the conversion from vertical lifting to horizontal movement, and in addition to the belt conveying mechanism, a combination of the module with a robotic arm and a seven-axis robot can be used to realize vertical lifting to horizontal movement.

Optionally, the first rotating mechanism 31, the second rotating mechanism 32 may be at least one of a rotating platform, a pneumatic motor, a pneumatic cylinder, and other mechanisms, and the rotation angle ranges from 0-360°.

The embodiment of present disclosure is able to drive the first horizontal conveying mechanism to rotate 0-360° through the first rotating mechanism, so that in the scenario where materials need to be transported to conveying belts at different angles, the angle can be freely adjusted to correspond with each conveying belt, which enhances the adaptability and flexibility of the lab material conveying device in different working scenarios, and realizes the conveying at different angles without the help of external mechanisms, which saves the structural cost and improves the working efficiency.

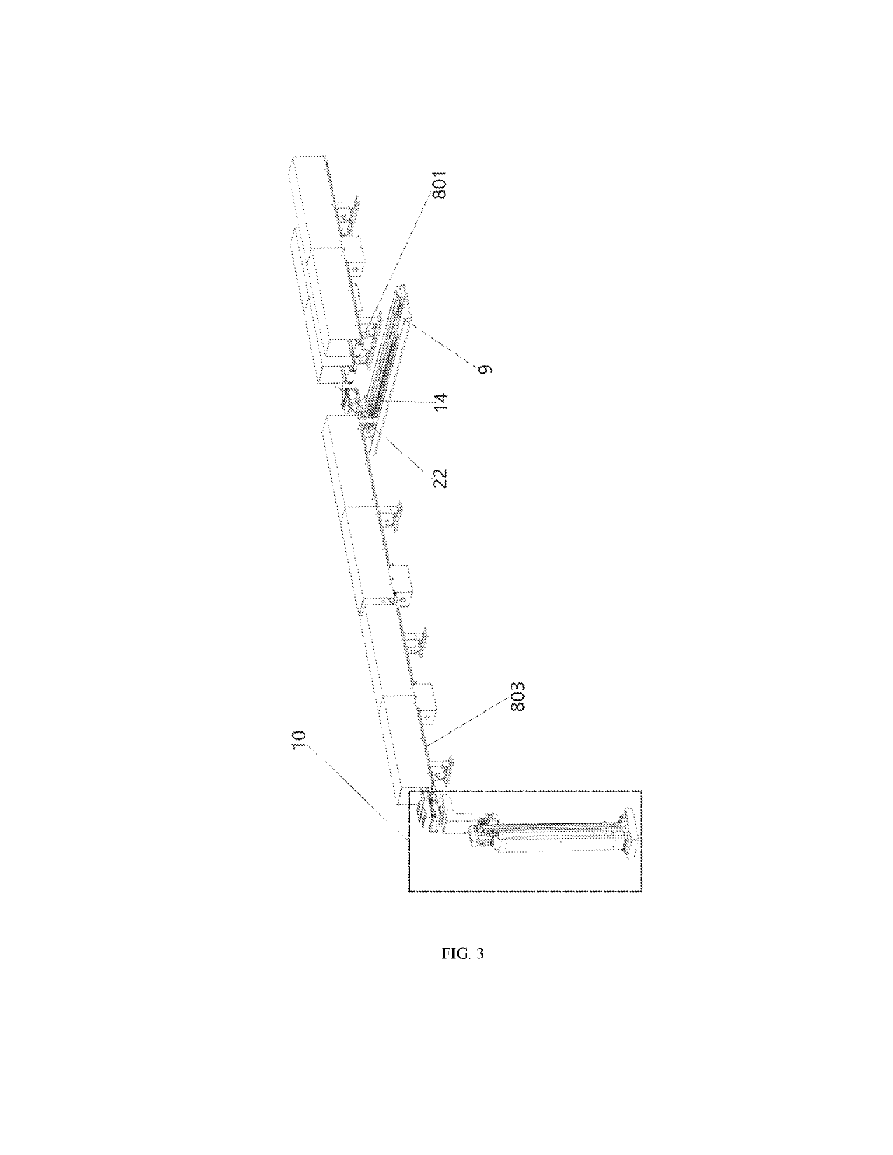

Please continue to refer to FIG. 1 and FIG. 3, the latter is a schematic diagram of a structure of a conveying belt device provided by embodiments of the present disclosure, in some optional embodiments, the first horizontal conveying mechanism 21 is provided with a barrier structure 14, the barrier structure 14 being located at a first predetermined location of the first horizontal conveying mechanism 21; the first predetermined location being, at a first predetermined distance from the first horizontal conveying mechanism 21 in the working surface of the first horizontal conveying mechanism 21 in the direction of the vertical line of the working surface, at a first predetermined distance from the working surface of the first horizontal conveying mechanism 21, the first predetermined distance being less than the height of the carrier 1;

The working surface of the first horizontal conveying mechanism 21 is the surface of the first horizontal conveying mechanism 21 in contact with the carrier 1.

It is to be noted that the use of "first", "second" and "third" to distinguish the horizontal conveying mechanism and the rotating mechanism in this specification is for the purpose of distinguishing between different applications, and that each of the horizontal conveying mechanisms may have the same structure. The horizontal conveying mechanisms may have the same structure, and the rotating mechanisms may also have the same structure. In order to ensure the conciseness of this specification, in the specific description, only the structure of any one of the horizontal conveying mechanisms or any one of the rotating mechanisms is described, and it is understood by those skilled in the art that the relevant description may also be applicable to the other horizontal conveying mechanisms or rotating mechanisms which are not directly specified.

Optionally, in order to ensure that the carrier can smoothly convey the material during transportation, a barrier structure 14 is provided on each horizontal conveying mechanism for stabilizing the carrier 1. In some optional embodiments, both ends of the barrier structure 14 are fixed to the first horizontal conveying mechanism 21 on both sides parallel to the conveying direction, for blocking the carrier 1 from sliding backward and forward in the conveying direction. The conveying direction refers to the conveying direction of the horizontal conveying mechanism, and if it is a belt conveying mechanism, it refers to the direction of the belt transmission.

Optionally, the barrier structure 14 is located at the first predetermined location of the first horizontal conveying mechanism 21, meaning that the top of the barrier structure coincides with the first predetermined location, and the first predetermined distance is less than the height of the carrier, where the height of the carrier refers to the height of the carrier itself, which does not change depending on the location where the carrier is placed.

Optionally, the barrier structure may be a sheet-like structure suspended from the working surface of the first horizontal conveying mechanism 21, or it may be a structure in contact with the working surface as shown.

By providing a barrier structure on the horizontal conveying mechanism, the embodiment of present disclosure is able to create an obstruction to the movement of the carrier in the conveying direction, prevent sliding between the carrier and the working surface of the horizontal conveying mechanism, resulting in material dumping, and is able to ensure the safety of the transportation of materials and the safety of personnel in the working room, and avoid pollution of the environment.

Reference is further made to FIGS. 1, 2, in some optional embodiments, the lab material conveying device further comprises a sensor 5, the sensor 5 being mounted on a side of the first horizontal conveying mechanism 21.

It should be noted that the sensor 5 serves to sense whether the material to be transported is carried in the carrier 1, and when the sensor 5 senses that the material to be transported has been placed in the carrier 1, it sends a signal to control the operation of the device. The sensor 5 in the present disclosure can use a variety of types of sensors 5, for example, photoelectric switch-type sensors 5; which can be divided into diffuse reflection sensors 5, convection-type sensors 5, specular reflection sensors 5 and so on, which can be flexibly selected according to the actual needs, and will not be repeated here.

By setting a sensor on the side of the horizontal conveying mechanism, the embodiment of present disclosure is able to sense whether the carrier is in place or not, and after sensing that the carrier is in place, send the carrier to a pre-set location, which improves the degree of automation and sensitivity of the material transportation, and improves the efficiency of the material transportation.

Reference is further made to FIG. 3, the present disclosure also proposes a conveying belt device, the conveying belt device comprising a conveying belt, at least one slide structure 9, at least one of the laboratory material conveying devices, a second horizontal conveying mechanism 22 and a second rotating mechanism 32, the second horizontal conveying mechanism 22 being slidably arranged on the slide structure 9 via the second rotating mechanism 32, and the slide structure 9 and the laboratory material conveying device are respectively provided in the surrounding area of the conveying belt 8.

Optionally, the conveying belt 8 may include a first conveying belt 801, a second conveying belt 802, and a third conveying belt 803, the first conveying belt 801 being used for switching the material transportation track, the second conveying belt 802 being used for realizing the bending of the material transportation direction, and the third conveying belt 803 being used for realizing the switching of the material transportation direction from a vertical direction to a horizontal direction.

As shown, the conveying belt device is provided with a laboratory material conveying device 10, which can realize the movement of the material in the vertical direction, and the setting of different conveying belts 8 as well as the slide structure 9 can realize the switching of the material conveying track on the same horizontal plane.

The embodiment of present disclosure, by setting up a variety of conveying belts, slide structures, laboratory material conveying devices and other mechanisms in the conveying belt device, enables the material transportation to reach any horizontal plane in the vertical direction, and then converts it to the horizontal direction, and changes the angle of the transportation direction and the track in the same horizontal plane, and is able to flexibly set up the transportation path according to the specified location, and transport the material to the specified location, and improves the flexibility of the material transportation. Due to the combination of a variety of transport belts and laboratory material conveying devices with vertical lifting function, compared with linear transportation, it can improve the integration of equipment in the space, increase the utilization of space, shorten the material conveying path, reduce the possibility of material dumping, and further ensure the safety of experiments and environmental cleanliness.

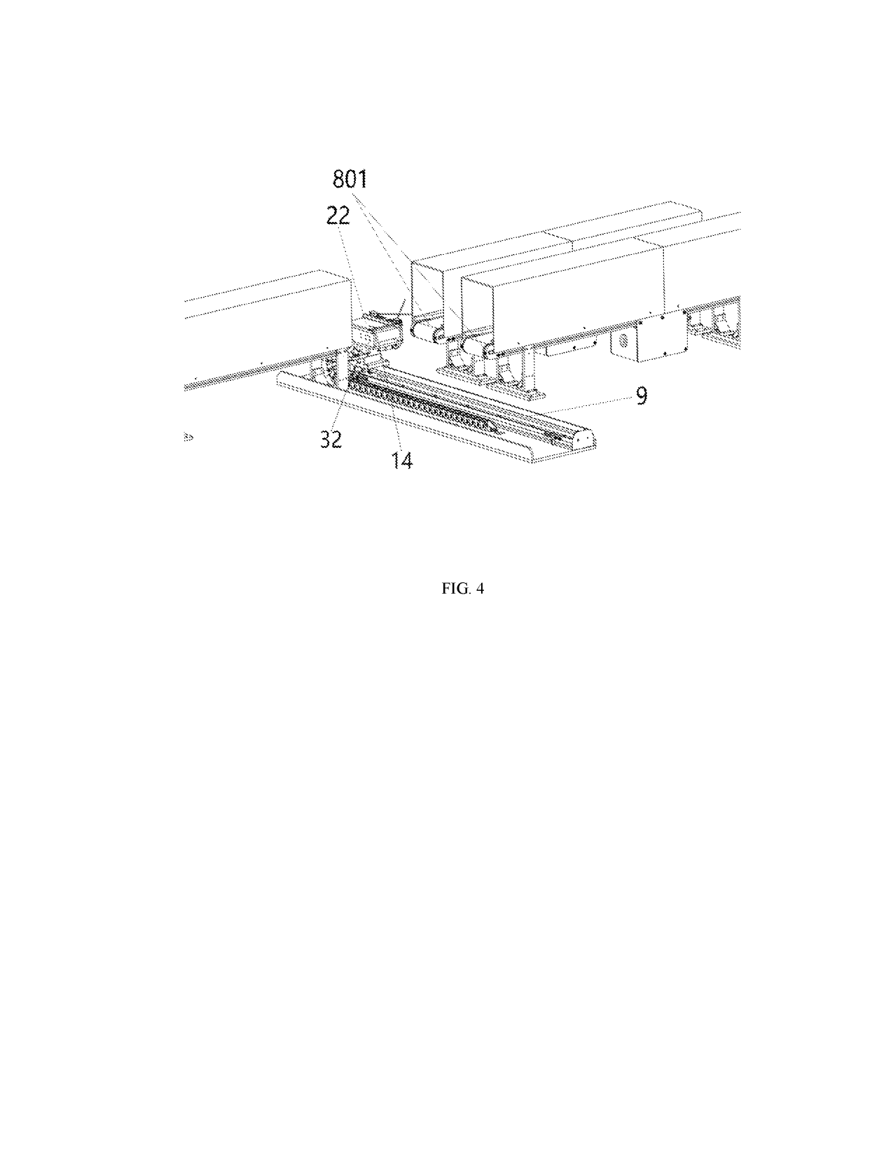

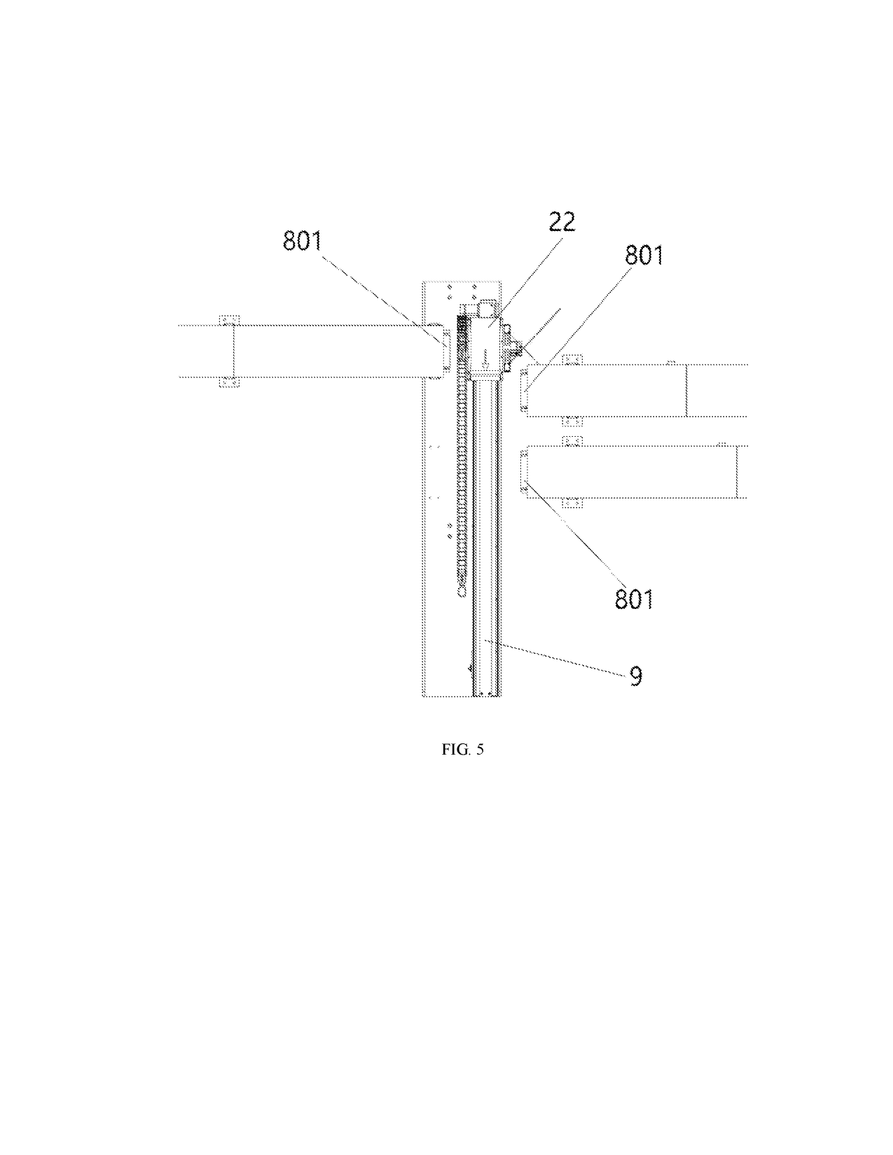

Reference is made FIGS. 4 and 5, FIG. 4 is a schematic diagram of a structure of a first conveying belt provided by an embodiment of the present disclosure I, and FIG. 5 is a schematic diagram II of a structure of a first conveying belt provided by an embodiment of the present disclosure; in some optional embodiments, the conveying belt comprises a first predetermined number of first conveying belts 801 transforming the track, and the angle between the first conveying belt 801 with the first predetermined number and the slide structure 9 ranges from 0-180°.

Optionally, the slide structure 9 is used to guide the second rotating mechanism 32 to slide along the track direction of the slide structure 9 to realize the track change, and as shown, a first conveying belt 801 is provided on both sides of the slide structure 9 perpendicular to the track direction, and optionally, the number of first conveying belts 801 may be two, three, four, five, and the like, and exemplarily, one side of the slide structure 9 is provided with one first conveying belt 801 for conveying to the second horizontal conveying mechanism 22 a material that requires a change in the conveying track, and one or more first conveying belts 801 with different conveying tracks are provided on the other side of the slide structure 9 for receiving the material.

Optionally, the angle range between the first conveying belt 801 and the slide structure 9 can be flexibly adjusted according to the setting of the material conveying path, and as shown the angle can be 90°.

The embodiment of present disclosure improves the flexibility of material transportation by providing a slide structure so that materials transported to the second horizontal conveying mechanism via the same first conveying belt can be transported to different other first conveying belts via the slide structure, thereby realizing a change in the transportation track.

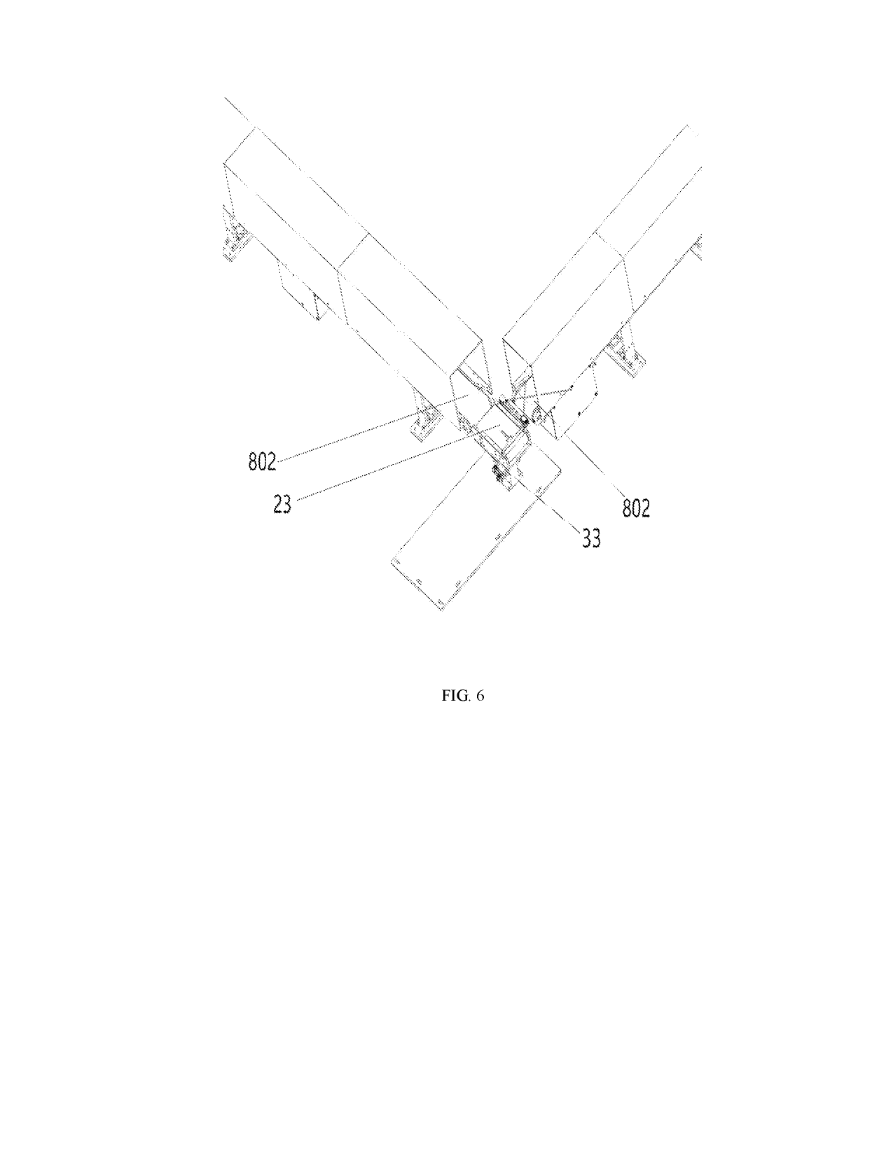

Reference is made to FIG. 6, FIG. 6 is a schematic diagram of a structure of a second conveying belt provided by an embodiment of the present disclosure, as shown, in some optional embodiments, the conveying belt 8 comprises a second predetermined number of second conveying belts 802 in a changing conveying direction, with an angle ranging from 0-180° between two adjacent the second conveying belts 802.

Optionally, the second predetermined number is at least 2, wherein one of the second conveying belts 802 is at an angle to the other second conveying belt 802 for realizing the turn and detour design of the transportation path.

Optionally, the adjacent two the second conveying belts 802 referred to in this specification means that the end of one of the second conveying belts 802 is connected to the first end of the other second conveying belt 802, wherein the connection may be a direct connection, at which time the angle of pinch between the two adjacent second conveying belts is 0°, which serves to prolong the length of the conveying path in the same conveying direction, or, as shown in FIG. 6, the two second conveying belts 802 are connected at intervals between the third horizontal conveying mechanism 23, which serves to change the conveying direction when the angle of pinch is greater than 0°.

Reference is further made to FIG. 6, in some optional embodiments, the conveying belt means further comprises a third rotating mechanism 33 and a third horizontal conveying mechanism 23 arranged on the third rotating mechanism 33, the third horizontal conveying mechanism 23 and the third rotating mechanism 33 being arranged between adjacent the second conveying belts 802; the working surface of the third horizontal conveying mechanism 23 being arranged in the same plane as the working surface of the adjacent second conveying belt 802.

Optionally, the third horizontal conveying mechanism 23 is used to carry the carrier conveyed by one of the second conveying belts 802 and convert the conveying direction, so that the new conveying direction is consistent with the conveying direction of the other second conveying belt 802. When the third horizontal conveying mechanism 23 completes the conversion of the conveying direction, the carrier is transported to the other second conveying belt 802 by the driving of the working surface, completing the conversion of the conveying direction between two adjacent second conveying belts 802.

The embodiment of present disclosure, by arranging two adjacent second conveying belts into a state with a certain angle between them, and setting up a third horizontal conveying mechanism between the second conveying belts, converts the conveying direction of the material from the conveying direction of the first second conveying belt to the conveying direction of the second conveying belt, realizes the turning and meandering of the material conveying path, and is capable of saving the required footprint compared to adopting the purely straight line material conveying path, and is beneficial for arranging other automation equipment to improve the space utilization, and is capable of shortening the material transport path, reducing the probability of material dumping during transport, and further improving safety and environmental cleanliness.

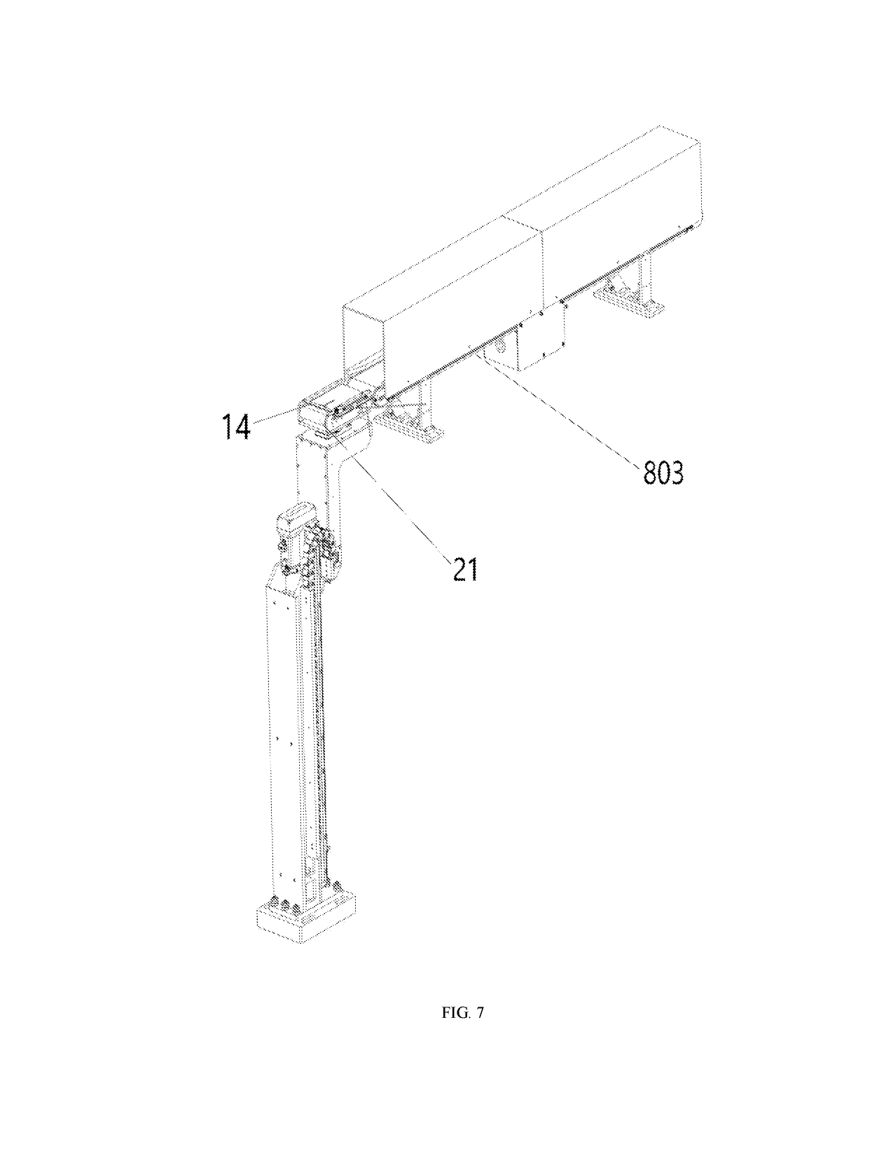

Reference is made to FIG. 7, FIG. 7 is a schematic diagram of a structure of a third conveying belt provided by an embodiment of the present disclosure. As shown, in some optional embodiments, the conveying belt 8 further includes a third conveying belt 803 that docks with the vertical lifting mechanism 6, and the third conveying belt 803 is arranged in a direction perpendicular to the vertical lifting mechanism 6; the end of the third conveying belt 803 being close to the vertical lifting mechanism 6 is a second predetermined distance away from the vertical lifting mechanism 6, the second predetermined distance being greater than or equal to the overall length of the first horizontal conveying mechanism 21 and less than a predetermined distance threshold.

It should be noted that the vertical lifting mechanism 6 can only realize the change of the position of the carrier 1 in the vertical direction, and even if the carrier 1 is transported to a position at the same height as the target position, there may exist a certain angle between the target position and the location where the carrier 1 is located, and in the case of directly driving the first horizontal conveying mechanism 21 for transporting the carrier without adjusting the position of the carrier 1, the carrier 1 arrives at a position that may deviate from the target position and even cause material spillage. In order to accurately deliver the carrier 1 to the target location, the first horizontal conveying mechanism 21 may be rotated by the first rotating mechanism 31 to adjust the relative angle between the carrier 1 and the target location, so that the carrier 1 can arrive at the target location smoothly through the horizontal conveying of the first horizontal conveying mechanism 21.

It is also noted that the third conveying belt 803 needs to receive material conveyed from the first horizontal conveying mechanism 21, and therefore, there needs to be sufficient space between the third conveying belt 803 and the vertical lifting mechanism 6 to accommodate the first horizontal conveying mechanism 21, and optionally, the first predetermined distance is greater than or equal to the overall length of the first horizontal conveying mechanism 21.

Optionally, the first predetermined distance is less than a predetermined distance threshold, and the predetermined distance threshold is a maximum value of the first predetermined distance, which may be practically determined in relation to the overall length of the first horizontal conveying mechanism 21, the size of the space holding the conveying belt device and the like.

The present disclosure provides a splicing arrangement of a conveying belt, a laboratory material conveying device, and a slide rail structure to establish a conveying path between different experimental modules of the same device or between different devices. A first conveying belt perpendicular to the slide rail structure is arranged to realize switching between different conveying paths at the same level. A second conveying belt is arranged to flexibly change the conveying direction of the material and realize cooperation with conveying belts in different directions. A third conveying belt, the material transportation can be switched from vertical to horizontal transport direction, and the material can be transported to different equipment or experimental modules, enriching the dimension of the transportation path. The conveying belt, laboratory material conveying device and slide rail device can be freely spliced to form transportation paths of different distances and angles, improving the flexibility of material transportation and the degree of automation adaptation, overcoming the problems of complex paths and complex mechanical equipment, and improving transportation safety.

In some optional embodiments, the working surface of the first horizontal conveying mechanism 21 and the working surface of the target conveying belt are at the same level when the distance of the plumb line segment between the working surface of the first horizontal conveying mechanism 21 and the bottom plane of the vertical lifting mechanism 6 is a third predetermined distance;

The working surface of the first horizontal conveying mechanism 21 is a surface on the first horizontal conveying mechanism 21 in contact with the carrier 1, the target conveying belt is a third conveying belt 803 to be reached by the carrier 1, and the working surface of the target conveying belt is a surface on the target conveying belt in contact with the carrier 1.

Optionally, the third predetermined distance is the shortest distance between the designated location and the bottom plane of the vertical lifting mechanism 6 when the carrier 1 needs to be transported to the designated location, the designated location being a predetermined location to which the carrier together with the material needs to be transported, and when the carrier 1 is transported to the designated location by the vertical lifting mechanism 6, the working surface of the first horizontal conveying mechanism 21 coincides with the horizontal plane where the designated location is located. Preferably, for smooth movement of the carrier 1 from the working surface of the first horizontal conveying mechanism 21 to the working surface of the target conveying belt, the two working surfaces are on the same horizontal plane.

It should also be noted that the vertical lifting mechanism 6 in the laboratory material conveying device 10 can realize switching of the transport path from the vertical direction to the horizontal direction, as well as switching of the transport path from the horizontal direction to the vertical direction, and by controlling the vertical lifting mechanism 6, it is possible to transport the carrier from the upper part to the lower part as well as from the lower part to the upper part in the vertical direction.

Optionally, the working surface is a surface in contact with the carrier and the device used for carrying and transporting carrier and material.

When the embodiment of present disclosure utilizes the vertical lifting mechanism to transport the first horizontal conveying mechanism together with the carrier to a designated location, the working surface of the first horizontal conveying mechanism is brought to the same level as the working surface of the target conveying belt, which ensures the smoothness of the material transportation, reduces the possibility of the material tipping, and ensures the safety of the material transportation and the cleanliness of the environment.

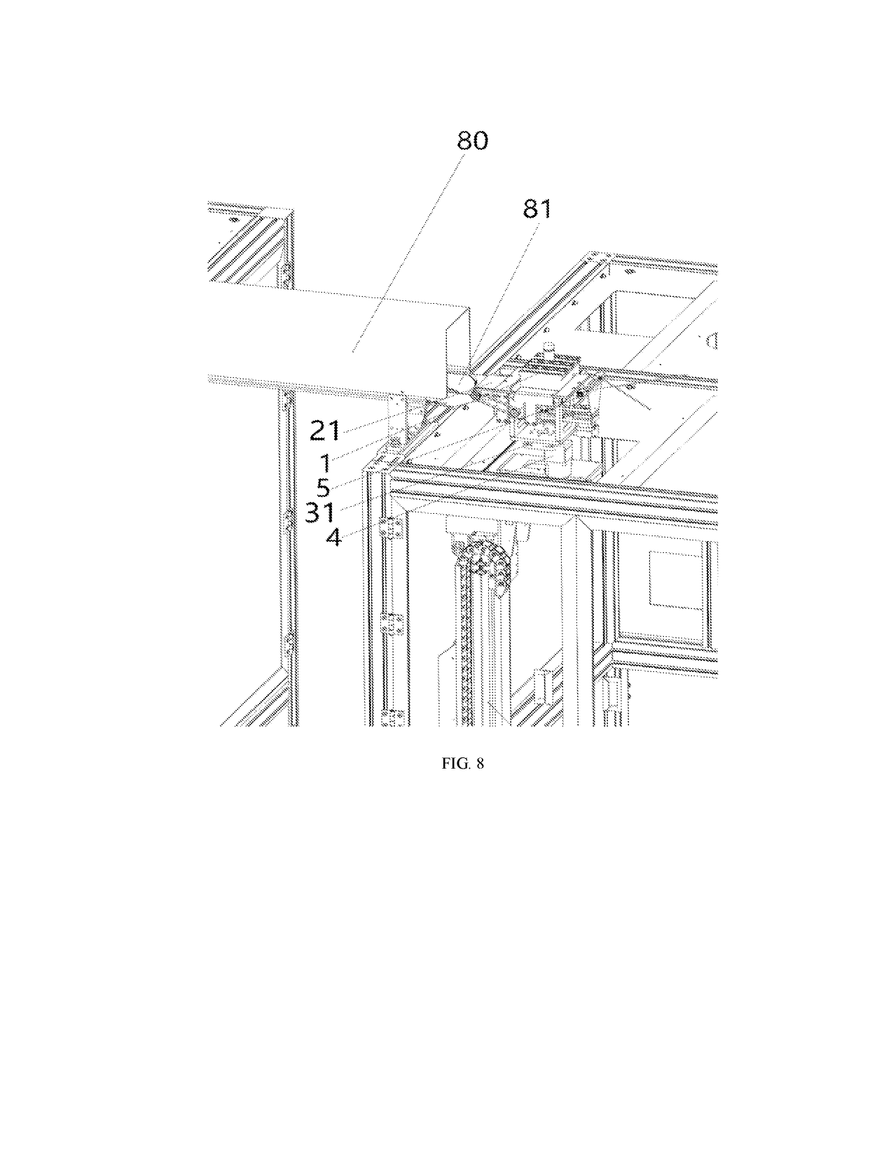

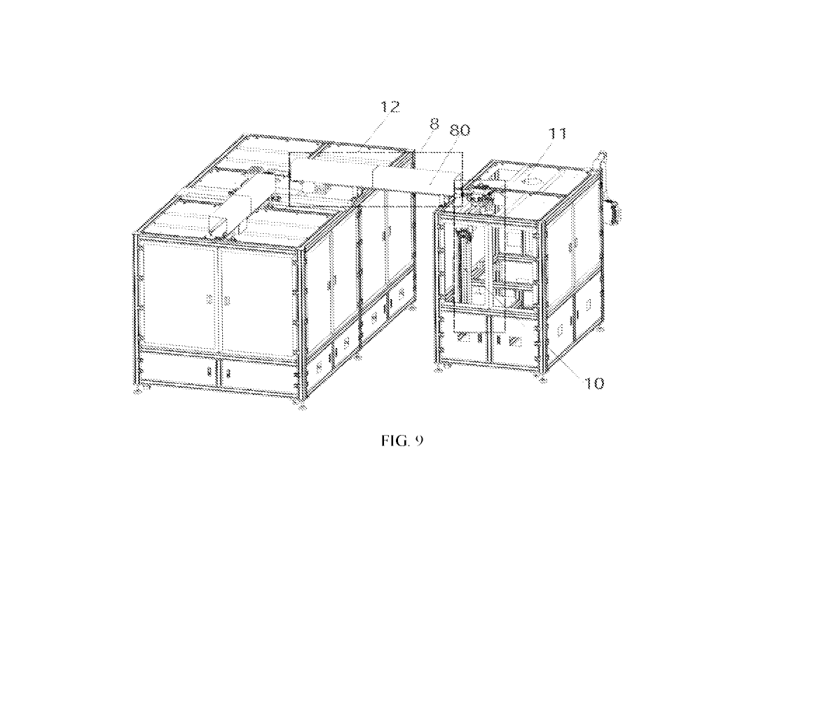

Reference is made to FIGS. 8 and 9, FIG. 8 is a working schematic diagram I of an apparatus provided by an embodiment of the present disclosure, and FIG. 9 is a working schematic diagram II of an apparatus provided by an embodiment of the present disclosure, as illustrated in the drawings, and in accordance with another aspect of the present disclosure, there is further disclosed an apparatus, the apparatus comprising the conveying belt means.

In some optional embodiments, the conveying belt 8 comprises a conveying belt shell 80 and a conveying belt body 81, the conveying belt shell 80 being fixedly arranged on a working surface of the conveying belt body 81.

Optionally, the conveying belt shell 80 is detachably fixed to the working surface of the conveying belt body 81, and it is to be noted that the function of the material transportation device is to transport the material from the loading location to the target location, the loading location being the location at which the material is located when the material is placed on the carrier 1, and the target location being the predetermined location at which the material is to be transported, and furthermore, the conveying belt shell 80 serves as a protector of the transportation process, to prevent material dumping caused by factors such as the overturning of the container holding the material on the carrier, which threatens personal safety and the environment.

By providing a conveying belt shell on the conveying belt body, the embodiment of present disclosure is able to prevent the material on the carrier from spilling out of the conveying belt device when dumping occurs, thereby preventing personal injury to the operator and avoiding environmental pollution.

It is also to be noted that if the next process after the horizontal conveying process requires a higher degree of positional accuracy, for example, the next segment requires the use of automated machinery such as a robotic arm to clamp the material, in order to ensure the positional accuracy of the carrier, the position of the carrier can also be adjusted with the positional adjusting mechanism to improve the positional accuracy of the transportation of the carrier, and optionally a centering device is adopted to center the position of the carrier and the material, and the center device can be used to centrally process the position of the carrier and the material. It can meet the high requirements of other links for the location accuracy of the material, and improve the accuracy of the experiment and the coordination among the links.

It is also to be noted that an experimental equipment includes a plurality of experimental modules, and in the application of automated laboratories, it is often necessary to transport materials from one equipment to another equipment or to transport materials between a plurality of experimental modules by means of a material transporting device, and by means of the conveying belt device provided by embodiments of the present disclosure, it is possible to realize the transport of materials between different experimental modules and a plurality of equipment in the same equipment.

The following description uses FIG. 9 as an example to illustrate the operating principle of the laboratory material conveying device 10 of the present disclosure in the equipment. As shown in FIG. 9, the first equipment 11 and the second equipment 12 are each provided with a laboratory material conveying device 10, and a conveying belt 8 is carried between the first equipment 11 and the second equipment 12. The two ends of the conveying belt 8 are respectively connected to the laboratory material conveying devices 10 in the first equipment 11 and the second equipment 12.

Further, in order to transport the reagent bottle A from the first equipment 11 to the second equipment 12, for example, the reagent bottle A is placed on the carrier 1 in the laboratory material conveying device 10 in the first equipment 11, the sensor 5 senses that the carrier 1 is carrying material, triggers a device switch, and the vertical lifting mechanism 6 drives the first horizontal conveying mechanism 21, and the first rotating mechanism 31 vertically upward to a specified location. After reaching the specified position, according to the preset angle, the drive motor 4 drives the first rotating mechanism 31 to rotate, so that the direction of the first horizontal conveying mechanism 21 drives in the same direction as the conveying direction of the conveying belt 8, the first horizontal conveying mechanism 21 operates, the carrier 1 is transported on the conveying belt, and the conveying belt 8 transports the carrier 1 together with the material to the second equipment 12, and arrives at the position where the laboratory material is located on the laboratory material conveying device 10 of the second equipment 12, the carrier 1 is transported together with the material to the first horizontal conveying mechanism 21 of the laboratory material conveying device 10, and then the laboratory material conveying device 10 in the second equipment 12 carries out a vertical lifting mechanism and other movements to transport the material to the desired location, thereby realizing the transportation of the material between the equipment.

In this embodiment of the disclosure, a material conveying device is arranged in the device so that the material can be transported to horizontal planes at different heights. The same horizontal plane can also achieve a variety of angles of transformation, improving the flexibility of material transportation. By arranging the first conveying belt, the second conveying belt, and the third conveying belt between the equipments, and by adjusting the arrangement of the starting points of the conveying belts, and arranging the first horizontal conveying mechanism, the second horizontal conveying mechanism, and the third horizontal conveying mechanism between the conveying belts, which cooperate with the first rotary mechanism, the second rotary mechanism, and the third rotary mechanism, respectively, a variety of material transportation routes can be freely set between different devices as needed, improving the efficiency and flexibility of transporting materials in the laboratory. Compared to the pure linear transport of materials, it saves space for the layout of the transport device, improves the effective use of space, and avoids long-distance transport, thereby reducing the risk of materials spilling. It does not need to rely on the assistance of other external equipment, reduces the structural complexity of the material conveying device, and thereby saves on device costs.

The present disclosure has the following beneficial effects:

1. The present disclosure makes the first horizontal conveying mechanism free to rotate to various angles on the same horizontal plane by setting the first rotating mechanism below the first horizontal conveying mechanism, enables vertical lifting and horizontal moving at the same time by mounting the first horizontal conveying mechanism on a vertical lifting mechanism, simplifies the structure of the equipment, can reduce the cost of the equipment's manufacturing, assembling, and maintenance, simplifies the process of transporting the material, saves material transportation time, improves the efficiency of material transportation, reduces the possibility of material loss during transportation, realizes the multi-angle transportation of the laboratory material conveying device, and improves the work efficiency, and overcomes the problem of a single direction of conveying by installing the first horizontal conveying mechanism on the first rotating mechanism, and adjusting the angle of the first rotating mechanism, so that the location of the first horizontal conveying mechanism corresponds to the entrance of the conveying belt. It can reduce the probability of material dumping and spilling, and improve the stability and safety in the process of material transportation.

2. By setting a drive motor in the lower part of the rotating mechanism, the embodiment of present disclosure makes the first horizontal conveying mechanism capable of flexibly adjusting the angle according to the need, improves the scene adaptability and flexibility of the material conveying device, and adopts a servo motor drive to improve the reaction speed and operation speed of the rotating mechanism, improves the working efficiency of the laboratory material conveying device, and saves the time of the material transportation.

3. The embodiment of present disclosure enhances the structural stability of the laboratory material conveying device by providing a mounting bracket to support the first horizontal conveying mechanism, the rotating mechanism, and the drive mechanism, thereby improving the stability of the material transportation, avoiding the loss caused by the material being spilled during the transportation process, providing support for the first horizontal conveying mechanism to be able to arrive at the target location, and improving the safety of the material transportation.

4. The embodiment of present disclosure is able to drive the first horizontal conveying mechanism to rotate 0-360° through the first rotating mechanism, so that in the scenario where materials need to be transported to conveying belts at different angles, the angle can be freely adjusted to correspond with each conveying belt, which enhances the adaptability and flexibility of the lab material conveying device in different working scenarios, and realizes the conveying at different angles without the help of external mechanisms, which saves the structural cost and improves the working efficiency.

5. By providing a barrier structure on the horizontal conveying mechanism, the embodiment of present disclosure is able to create an obstruction to the movement of the carrier in the conveying direction, prevent sliding between the carrier and the working surface of the horizontal conveying mechanism, resulting in material dumping, and is able to ensure the safety of the transportation of materials and the safety of personnel in the working room, and avoid pollution of the environment.

6. By setting a sensor on the side of the horizontal conveying mechanism, the embodiment of present disclosure is able to sense whether the carrier is in place or not, and after sensing that the carrier is in place, send the carrier to a pre-set location, which improves the degree of automation and sensitivity of the material transportation, and improves the efficiency of the material transportation.

7. The embodiment of present disclosure, by setting up a variety of conveying belts, slide structures, laboratory material conveying devices and other mechanisms in the conveying belt device, enables the material transportation to reach any horizontal plane in the vertical direction, and then converts it to the horizontal direction, and changes the angle of the transportation direction and the track in the same horizontal plane, and is able to flexibly set up the transportation path according to the specified location, and transport the material to the specified location, and improves the flexibility of the material transportation. Due to the combination of a variety of transport belts and laboratory material conveying devices with vertical lifting function, compared with linear transportation, it can improve the integration of equipment in the space, increase the utilization of space, shorten the material conveying path, reduce the possibility of material dumping, and further ensure the safety of experiments and environmental cleanliness.

8. The embodiment of present disclosure improves the flexibility of material transportation by providing a slide structure so that materials transported to the second horizontal conveying mechanism via the same first conveying belt can be transported to different other first conveying belts via the slide structure, thereby realizing a change in the transportation track.

9. The embodiment of present disclosure, by arranging two adjacent second conveying belts into a state with a certain angle between them, and setting up a third horizontal conveying mechanism between the second conveying belts, converts the conveying direction of the material from the conveying direction of the first second conveying belt to the conveying direction of the second conveying belt, realizes the turning and meandering of the material conveying path, and is capable of saving the required footprint compared to adopting the purely straight line material conveying path, and is beneficial for arranging other automation equipment to improve the space utilization, and is capable of shortening the material transport path, reducing the probability of material dumping during transport, and further improving safety and environmental cleanliness. Compared with the use of a purely linear material conveying path, the space required can be saved, the utilization rate of the space can be improved, and it is conducive to the arrangement of other automated equipment and the improvement of production efficiency, and the path of material transportation can be shortened, the probability of material dumping during transportation can be reduced, and the safety and cleanliness of the environment can be further improved.

10. The present disclosure builds a transportation path between different experimental modules of the same equipment and between different equipment by splicing and setting up a conveying belt, a lab material conveying device, and a slide structure, realizing the switching of the same horizontal plane and different transportation tracks by setting up a first conveying belt perpendicular to the slide structure, enabling flexible change of the transportation direction of the material by setting up a second conveying belt, realizing the transportation belt with different directions of matching, through the third conveying belt so that the material transport can realize the vertical to horizontal transport direction switching, can be transported to the material to different equipment or experimental modules, enriching the dimension of the transport path, the conveying belt, laboratory material conveying device and slide rail device, etc., free splicing, constituting different distances, different angles of the conveying path to improve the flexibility of material transport and automation adaptability, overcoming the problems of complex paths and complex mechanical equipment, and improving transportation safety.

11. When the embodiment of present disclosure utilizes the vertical lifting mechanism to transport the first horizontal conveying mechanism together with the carrier to a designated location, the working surface of the first horizontal conveying mechanism is brought to the same level as the working surface of the target conveying belt, which ensures the smoothness of the material transportation, reduces the possibility of the material tipping, and ensures the safety of the material transportation and the cleanliness of the environment.

12. By providing a conveying belt shell on the conveying belt body, the embodiment of present disclosure is able to prevent the material on the carrier from spilling out of the conveying belt device when dumping occurs, thereby preventing personal injury to the operator and avoiding environmental pollution.

13. In this embodiment of the disclosure, a material conveying device is arranged in the device so that the material can be transported to horizontal planes at different heights. The same horizontal plane can also achieve a variety of angles of transformation, improving the flexibility of material transportation. By arranging the first conveying belt, the second conveying belt, and the third conveying belt between the equipments, and by adjusting the arrangement of the starting points of the conveying belts, and arranging the first horizontal conveying mechanism, the second horizontal conveying mechanism, and the third horizontal conveying mechanism between the conveying belts, which cooperate with the first rotary mechanism, the second rotary mechanism, and the third rotary mechanism, respectively, a variety of material transportation routes can be freely set between different devices as needed, improving the efficiency and flexibility of transporting materials in the laboratory. Compared to the pure linear transport of materials, it saves space for the layout of the transport device, improves the effective use of space, and avoids long-distance transport, thereby reducing the risk of materials spilling. It does not need to rely on the assistance of other external equipment, reduces the structural complexity of the material conveying device, and thereby saves on device costs.

It should be noted that the above sequence of embodiments of the present disclosure is only for the purpose of description, and does not represent the advantages or disadvantages of the embodiments. And the above describes the specific embodiment of the present specification. Other embodiments are within the scope of the appended Claims.

The foregoing is only a preferred embodiment of the present disclosure and is not intended to limit the present disclosure, and any modifications, equivalent replacements, improvements, etc., made within the spirit and principles of the present disclosure shall be included in the scope of protection of the present disclosure.

What is claimed is:

1. A laboratory material conveying device, comprising a vertical lifting mechanism, a first rotating mechanism and a first horizontal conveying mechanism, the first horizontal conveying mechanism being provided on the first rotating mechanism, the first rotating mechanism being mounted on the vertical lifting mechanism, the first horizontal conveying mechanism on which a carrier is placed, the carrier being provided with a holding space for accommodating the material to be conveyed.

2. The device according to claim 1, further comprising a drive motor, the drive motor being provided in a lower part of the first rotating mechanism, the drive motor being electrically connected to the first rotating mechanism.

3. The device according to claim 2, further comprising a mounting bracket, the first rotating mechanism and the drive motor being mounted on the vertical lifting mechanism via the mounting bracket.

4. The device according to claim 3, wherein the first horizontal conveying mechanism is a belt conveying mechanism, the belt conveying mechanism comprising a transmission mechanism, which is provided with a winding belt, the transmission mechanism having a rotating direction in a counterclockwise direction or a clockwise direction.

5. The device according to claim 1, wherein the first horizontal conveying mechanism is provided with a barrier structure, the barrier structure being located at a first predetermined location of the first horizontal conveying mechanism; the first predetermined location being, in a direction of a plumb line of a working surface of the first horizontal conveying mechanism, at a first predetermined distance from the working surface of the first horizontal conveying mechanism, the first predetermined distance being less than a height of the carrier; and
the working surface of the first horizontal conveying mechanism is the surface of the first horizontal conveying mechanism in contact with the carrier.

6. The device according to claim 5, wherein the laboratory material conveying device further comprises a sensor, the sensor being mounted on a side of the first horizontal conveying mechanism.

7. A conveying belt device, comprising a conveying belt, at least one slide structure, at least one laboratory material conveying device , a second horizontal conveying mechanism and a second rotating mechanism, the second horizontal conveying mechanism being slidably arranged on the slide structure via the second rotating mechanism, and the slide structure and the laboratory material conveying device being provided in a surrounding area of the conveying belt respectively; and
wherein the at least one laboratory material conveying device comprises a vertical lifting mechanism, a first rotating mechanism and a first horizontal conveying mechanism, the first horizontal conveying mechanism being provided on the first rotating mechanism, the first rotating mechanism being mounted on the vertical lifting mechanism, the first horizontal conveying mechanism on which a carrier is placed, the carrier being provided with a holding space for accommodating the material to be conveyed.

8. The device according to claim 7, wherein the conveying belt comprises a first predetermined number of first conveying belts transforming a track, and an angle between the first conveying belts with the first predetermined number and the slide structure ranges from 0-180°.

9. The device according to claim 7, wherein the conveying belt comprises a second predetermined number of second conveying belts changing a conveying direction, an angle between two adjacent the second conveying belts ranging from 0-180°.

10. The device according to claim 9, further comprising a third rotating mechanism and a third horizontal conveying mechanism provided on the third rotating mechanism, the third horizontal conveying mechanism and the third rotating mechanism being provided between adjacent the second conveying belts; the third horizontal conveying mechanism has a working surface in the same plane as the working surface of the adjacent the second conveying belt.

11. The device according to claim 7, further comprising a third conveying belt docked with the vertical lifting mechanism, the third conveying belt is arranged in a direction perpendicular to the vertical lifting mechanism; an end of the third conveying belt being close to the vertical lifting mechanism is a second predetermined distance away from the vertical lifting mechanism, the second predetermined distance being greater than or equal to an overall length of the first horizontal conveying mechanism and less than a predetermined distance threshold.

12. The device according to claim 11, wherein a working surface of the first horizontal conveying mechanism and the working surface of a target conveying belt are in the same horizontal plane when the distance of a plumb line segment between the working surface of the first horizontal conveying mechanism and a bottom plane of the vertical lifting mechanism is a third predetermined distance; and
the working surface of the first horizontal conveying mechanism is the surface on the first horizontal conveying mechanism in contact with the carrier, and the target conveying belt is a third conveying belt to be reached by the carrier, and the working surface of the target conveying belt is the surface on the target conveying belt in contact with the carrier.

13. The device according to claim 7, wherein the conveying belt comprises a conveying belt shell and a conveying belt body, the conveying belt shell being fixedly arranged on a working surface of the conveying belt body.

14. An equipment, wherein the equipment comprises a conveying belt device comprising a conveying belt, at least one slide structure, at least one laboratory material conveying device , a second horizontal conveying mechanism and a second rotating mechanism, the second horizontal conveying mechanism being slidably arranged on the slide structure via the second rotating mechanism, and the slide structure and the laboratory material conveying device being provided in a surrounding area of the conveying belt respectively; and
wherein the at least one laboratory material conveying device comprises a vertical lifting mechanism, a first rotating mechanism and a first horizontal conveying mechanism, the first horizontal conveying mechanism being provided on the first rotating mechanism, the first rotating mechanism being mounted on the vertical lifting mechanism, the first horizontal conveying mechanism on which a carrier is placed, the carrier being provided with a holding space for accommodating the material to be conveyed.
